(19) United States
(12) Patent Application Publication
(10) Pub. No.: US 2010/0203766 A1
(43) Pub. Date: Aug. 12, 2010

(54) ELECTRICAL CONNECTOR HAVING DUAL-SOLDERING SURFACES

(75) Inventors: GUO-JIAN SHEN, Kunshan (CN); CHI ZHANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/701,584

(22) Filed: Feb. 7, 2010

(30) Foreign Application Priority Data
Feb. 9, 2009 (CN) 200920300522.8

(51) Int. Cl. H01R 25/00

(52) U.S. Cl. 439/638

(57) ABSTRACT

An electrical connector comprises an insulative housing (1) and a plurality of terminals (2) retained in the housing. The housing defines a first wall (11), a second wall (12) and a pair of sides (13) connecting the first and second walls thereby defining a receiving room (10) theretween. The terminals are inserted into said receiving room along a rear-to-front direction, and each comprises a first solder portion (24) and a second solder portion (25) respectively extending toward the first wall and second wall. The first and second solder portions respectively define a first (241) and a second mounting faces (251) in a parallel relationship and sandwiching the first and second walls theretween.

### BACKGROUND OF THE INVENTION

1. Field of the Invention

The present invention relates to an electrical connector, and more particularly to an electrical connector having soldering surfaces suitable for mounting onto a printed circuit board according to field requirements.

2. Description of the Related Art

Electrical connectors for receiving flexible printed circuit (FPC) or flat flexible cable (FFC) generally includes three types: an actuator type which defines an actuator assembled onto an insulative housing and rotated from an opened position, where an FPC can be inserted into the insulative housing, to a closed position, where the actuator presses against terminals retained in the housing to electrically contact with the FPC; a slider type, which includes an insulative housing with a slider mounted therein, the insulative housing defining a wide opened receiving cavity for receiving an FPC when the slider is not inserted therein, then the slider is inserted into the receiving cavity and pressing against the FPC; and a direct insertion type, which defines an insulative housing defining a receiving cavity with contacts at opposite sides thereof, an FPC can be directly inserted into the receiving cavity and electrically contacted with the contacts. U.S. Pat. Pub. No. 2007/0054558 published to Harlan et al. on Mar. 8, 2007, U.S. Pat. No. 6,939,166 issued to Chung on Sep. 6, 2005, and Japanese design Pat. No. 1139130 respectively disclose electrical connectors of these three types.

The electrical connectors, especially the direct insertion type connectors, become smaller and smaller according to the miniaturization trend of the electronic devices, therefore, it is not easy for distinguishing which side is the top side of the electrical connector when the electrical connector is adapted to be mounted onto the printed circuit board, which is not advantage for mounting procedure. Hence, an electrical connector which can solve the problem is highly required.

### SUMMARY OF THE INVENTION

An object of the present invention is to provide an electrical connector which is convenient for the soldering procedure.

In order to achieve the above-mentioned object, an electrical connector comprises an insulative housing and a plurality of terminals retained in the housing. The housing defines a first wall, a second wall and a pair of sides connecting the first and second walls thereby defining a receiving room theretween. The terminals are inserted into said receiving room along a rear-to-front direction, and each comprises a first solder portion and a second solder portion respectively extending toward the first wall and second wall. The first and second solder portions respectively define a first and a second mounting faces in a parallel relationship and sandwiching the first and second walls theretween.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector mounted onto a printed circuit board in accordance with an embodiment of the present invention;

FIG. 2 is another perspective view of the electrical connector mounted on the printed circuit board shown in FIG. 1;

FIG. 3 is an exploded perspective view of the electrical connector shown in FIG. 1; and

FIG. 4 is a cross sectional view of the electrical connector taken along line 4-4 of FIG. 1.

### DETAILED DESCRIPTION OF THE INVENTION

Reference will now be made to the drawing figures to describe the preferred embodiment of the present invention in detail.

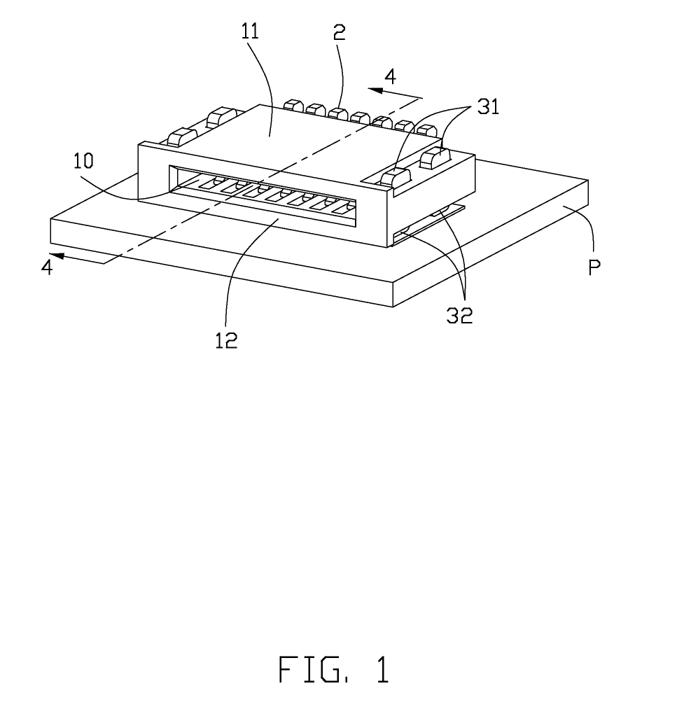

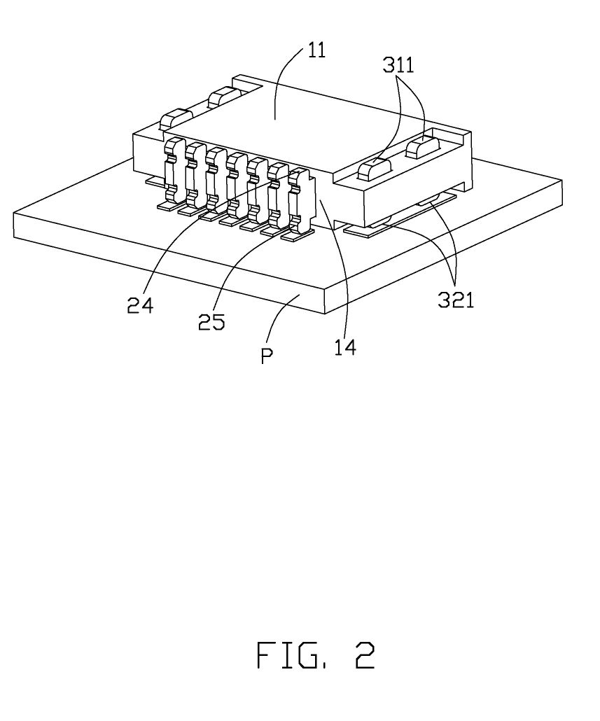

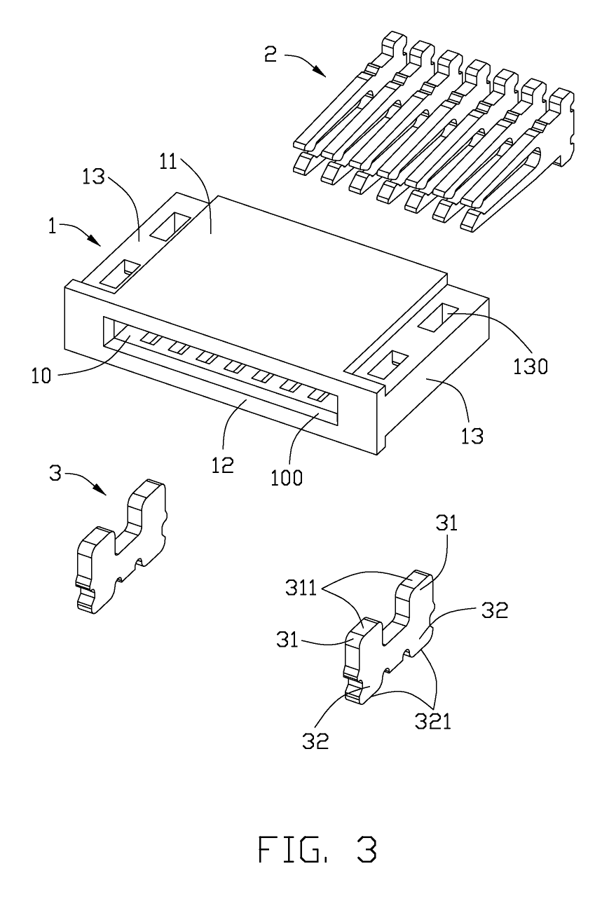

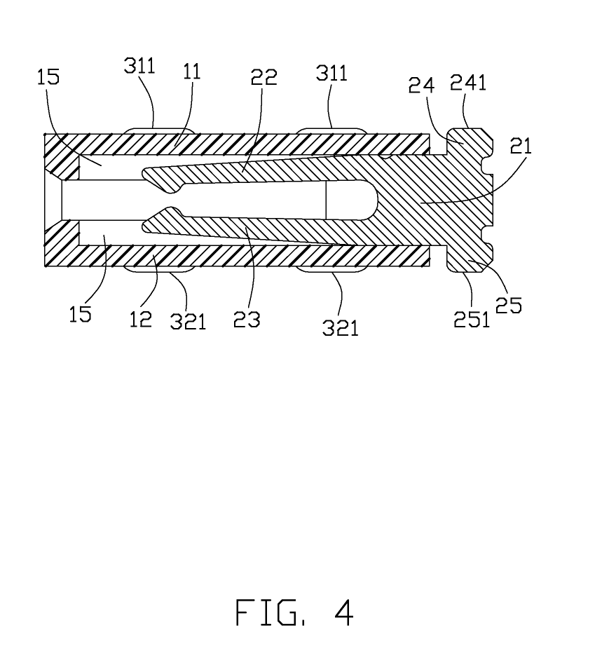

Referring to FIG. 1 and FIG. 2, an electrical connector made in accordance with the present invention is provided and mounted on a printed circuit board P for transmitting signals. Referring to FIG. 3, the electrical connector comprises an insulative housing 1, a plurality of terminals 2 disposed in the housing 1 and a pair of metallic pads 3 retained at opposite ends of the housing respectively. The housing 1 comprises a first side wall 11, a second side wall 12 opposite to the first side wall 11, two end walls 13 joining with the two side walls 11, 12 and a back wall 14 connecting with the end walls 13 and side walls 11, 12. A receiving room 10 is defined between the two side walls 11, 12 and has an opening 100 opened forwardly. A pair of through holes 130 are defined on each end wall 13 and run therethrough along a vertical direction. Referring to FIG. 4, a plurality of passageways 15 extend from the back wall 14 and extend forward along inner faces of the side walls 11, 12 in a rear-to-front direction.

Referring to FIG. 3 and FIG. 4, each terminal 2 includes a base portion 21 located in the passageway 15, a first and a second contact arms 22, 23 separately formed and perpendicularly extending forward from opposite sides of the base portion 21, and a first and second solder portions 24, 25 extending reversely from opposite edges of the base portion 21. The plurality of terminals 2 are inserted into the passageways 15 along the rear-to-front direction with the first and second contact arms 22, 23 projecting into the receiving room 10. The first and second contact arms 22, 23 are face-to-face arranged so as to electrically contact with a flexible printed circuit inserted therebetween. Moreover, the terminals 2 are disposed in the housing 1 along a transverse direction perpendicular to the rear-to-front direction and define a fixed pitch between each other. The first solder portion 24 extends toward the first side wall 11 and define a first mounting face 241 slightly higher than the first side wall 11. The second solder portion 25 extend toward the second side wall 12 and define a second mounting face 251 slightly lower than the second side wall 12. The first and second mounting face 241, 251 are parallel to each other and symmetrically arranged.

Referring to FIG. 1 to FIG. 3, the metallic pad 3 is configured into a board-like shape and is received in the through hole 130 of the housing 1. Each of the metallic pads 3 comprises a pair of first projecting portions 31 protruding toward the first side wall 11 and a pair of second projecting portions 32 protruding toward the second side wall 12. The first and second projecting portions 31, 32 are symmetrically arranged and respectively define a first face 311 and a second face 321 at opposite sides thereof. The first face 311 and the first mounting face 241 are substantially in a same horizontal level and designated as a first soldering face which is in compliance with traces on the printed circuit board P. Similarly, the second face 321 and the second mounting face 251 are also in a same horizontal level and designated as a second soldering face which is in compliance with the same trances on the printed circuit board P.

When the electrical connector is mounted on to the printed circuit board P, either the first soldering face or the second soldering face can be soldered onto the corresponding traces on the printed circuit board P and realize the signal transmission, which is benefit for improving the efficiency of the mounting procedure of the electrical connector.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a first wall, a second wall and a pair of sides connecting the first and second walls thereby defining a receiving room theretween; and
a plurality of terminals inserted into said receiving room along a rear-to-front direction, and each comprising a first solder portion and a second solder portion respectively extending toward the first wall and second wall;
wherein the first and second solder portions respectively define a first and a second mounting faces in a parallel relationship and sandwiching the first and second walls theretween.

2. The electrical connector as described in claim 1, wherein the first and second mounting faces are symmetrical with regard to the insulative housing.

3. The electrical connector as described in claim 2, wherein each of the terminals has a pair of contact arms disposed in the receiving room and oppositely arranged.

4. The electrical connector as described in claim 1, further comprising a pair of metallic pads retained in said sides respectively, wherein each metallic pad comprises a first projecting portion and a second projecting portion extending reversely and respectively defining a first face horizontally to the first mounting face and a second face horizontally to the second mounting face.

5. The electrical connector as described in claim 4, wherein the first and second projecting portions of the metallic pads are arranged in front of the first and second solder portions of the terminals along the rear-to-front direction.

6. An electrical connector comprising:
an insulative housing having an upper wall, a lower wall, and a pair of sides connecting the upper wall and lower wall, and a receiving cavity defined between said upper and lower walls and extending along a rear-to-front direction;
a plurality of terminals inserted into said receiving cavity; and
a pair of metallic pads secured in said sides;
wherein the terminals and metallic pads commonly defining a first and a second soldering faces in a parallel relationship.

7. The electrical connector as described in claim 6, wherein each contact has a first and second solder portions symmetrically arranged with regard to the insulative housing.

8. The electrical connector as described in claim 7, wherein each metallic pad has a first and a second projecting portions symmetrically.

9. An electrical connector comprising:
an insulative housing defining a pair of side walls with therebetween in a lateral direction a mating port in communication with an exterior in a front-to-back direction perpendicular to said lateral direction, via a front opening in a front face of the housing;
a plurality of contacts disposed in the housing with contacting section extending into the mating port and soldering sections on a rear face of the housing; wherein
each of said soldering sections defines two opposite soldering faces respectively exposed outside of the corresponding side walls in the lateral direction so as to allow soldering said connector upon a printed circuit board on opposite orientations.

10. The electrical connector as claimed in claim 9, further including a plurality of mounting pads having mounting faces respectively exposed upon the opposite side walls.

11. The electrical connector as claimed in claim 10, wherein each of said mounting pads has two mounting faces respectively exposed upon the opposite side walls.
